(19) United States
(12) Patent Application Publication
(10) Pub. No.: US 2023/0394480 A1
(43) Pub. Date: Dec. 7, 2023

(54) Method and Related Systems for Minting and Transacting Non-Fungible Enterprise Loyalty Tokens

(71) Applicant: Valeriy Kleyman, Freehold, NJ (US)

(72) Inventor: Valeriy Kleyman, Freehold, NJ (US)

(21) Appl. No.: 17/834,759

(22) Filed: Jun. 7, 2022

(51) Int. Cl. G06Q 20/38; G06Q 30/02

(52) U.S. Cl. CPC G06Q 20/389; G06Q 30/0226; G06Q 20/36

(57) ABSTRACT

The present disclosure provides a method and related systems for allowing business owners to tokenize intangible assets such as intellectual property, customer loyalty, and store credit through NFTs by providing a platform that mints the NFTs for them. The method involves receiving a request form such a business owner, verifying that they meet one or more predefined conditions, and once verified, issuing a set of one or more NFTs associated with their business and creating an NFT marketplace for them. The business owners can then use the issued tokens as they please to reward and increase customer loyalty while earning revenue from any transactions carried out involving the NFTs associated with them.

### FIELD OF INVENTION

The present invention relates generally to the field of blockchain-based non-fungible token transactions. More specifically, the present invention relates to methods for tokenizing customer loyalty for enterprises and institutions.

### BACKGROUND

Modern day advances in computing technology and corporate complexity have increased the potential revenue streams for intelligent property owners and businesses. People can control their income streams from an electrical device now more than ever, and one method by which many users are seeking to do this is through the use of Non-Fungible Tokens (NFTs), a new type of blockchain-based intellectual property.

The term blockchain is typically used to refer to a distributed ledger that can record transactions between two computer systems efficiently and in a verifiable and permanent way. The permanence of records written to a blockchain is the reason that blockchains can be considered to be a form of immutable ledger. Transactions between computers recorded in a blockchain cannot be altered retroactively without the alteration of all subsequent blocks. Blockchain technology ensures the coherence and continuity of each node in a distributed database, so that information can be verified and traceable in real time, but it is difficult to tamper with and cannot be shielded, thus creating a private, efficient and secure shared value system. Blockchains can be used to “mint” and trade Non-Fungible Tokens.

The term “Non-Fungible Token” (NFT) has recently gained popularity for describing blockchain-based cryptographic tokens that are created with respect to a specific piece of content and which incorporate programmatically defined digital rights management. NFTs can be implemented on blockchains that support smart contracts in a manner that results in verifiable scarcity. In many instances, each NFT has a unique serial number and the NFT smart contract defines an interface that enables the NFT to be managed, owned and/or traded. A number of standards have emerged for defining interfaces for building NFTs on the Ethereum blockchain including (but not limited to) ERC-721 and ERC-1155, the disclosures of which are herein incorporated by reference in their entirety. NFTs can be contrasted with interchangeable or fungible tokens (e.g. Ether). Fungible tokens can be implemented on the Ethereum blockchain based upon standard interfaces including (but not limited to) the ERC-20 standard, the disclosure of which is incorporated by reference herein in its entirety.

The Non-Fungible Token (NFT) under the Ethereum ERC721 protocol has the characteristics of uniqueness, traceability, and non-tampering, and is being widely used. NFTs utilizing this protocol, and similar protocols are thus a perfectly suited mechanism for tokenizing intangible assets such as customer loyalty and store credit and gift cards. Despite this, users are still limited in the methods by which they can conduct NFT transactions, tokenize their assets, and leverage existing hidden value through doing so.

Generally, the current transaction modes for NFTs are limited to two-way transactions, where two parties agree on the trade of an already minted NFT via a proprietary smart contract. Both parties to the transaction need to confirm and sign the transaction using a Web3 Wallet. While this has led to many interesting developments, the level of technological know-how required to mint new NFTs has proved prohibitive, and limited their usefulness to peer-to-peer trading of already existing NFTs, apart form a select few technologically capable individuals and businesses.

There is a need for a more convenient and reliable NFT minting method, which is more accessible by the general public and businesses which are less tech savvy.

It is within this context that the present invention is provided.

### SUMMARY

The present disclosure provides a method and related systems for allowing business owners to tokenize intangible assets such as intellectual property, customer loyalty, and store credit through NFTs by providing a platform that mints the NFTs for them. The method involves receiving a request form such a business owner, verifying that they meet one or more predefined conditions, and once verified, issuing a set of one or more NFTs associated with their business and creating an NFT marketplace for them. The business owners can then use the issued tokens as they please to reward and increase customer loyalty while earning revenue from any transactions carried out involving the NFTs associated with them.

Thus, according to one aspect of the present disclosure there is provided a computer-implemented method for issuing and transacting non-fungible tokens, NFTs, the method comprising the steps of: receiving, from a first user, a request to generate an NFT associated with a first business enterprise; verifying, by a server, that the first user meets a set of predefined requirements; upon determining that the first user meets the predefined requirements, minting one or more NFTs associated with the first business on a first blockchain and registering the one or more NFTs to an electronic wallet associated with the first user; receiving a request from the first user to transfer or trade one or more of the NFTs with a second user having a second electronic wallet associated with them on the first blockchain; and changing the ownership of the one or more NFTs on the first blockchain to the second user.

Each NFT minted for the first business is secured by the intellectual property of that business and is configured so as to be exchanged for an enterprise reward at a given location or to represent a portion of the intellectual property of that business.

In some embodiments, the method further comprises, for each NFT transferred to a second user, issuing a Unique Lifetime Benefit tied to the transferred NFT to the account of the second user, the Unique Lifetime Benefit entitling the second user to rewards from a business of a first user that requested the NFT be minted.

In some embodiments, the predefined requirements verified in the second step comprise verifying that a contract has been signed by the first user.

In some embodiments, the method further comprises the step of generating an online marketplace, accessible by one or more user devices, associated with the first user and the first business, the online marketplace listing one or more NFTs minted for and issued to the first user.

In such embodiments, the method may further comprise the step of generating a unique identifier associated with the online marketplace, the unique identifier being configured when scanned by a user device to direct the user device to the online marketplace of the associated first user.

The unique identifier may be a QR code. The unique identifier may also be associated with a physical geographical location, and wherein the method further comprises storing the geographical location of each unique identifier generated on a database.

The method may then further comprise generating a virtual map, accessible by one or more user devices, the virtual map indicating a plurality of geographical locations where unique identifiers for the online marketplaces of respective business are located.

In such embodiments, the method may further comprise the steps of: determining that one or more new NFTs have been minted and associated with a geographical location; determining a number of second users within a predefined radius of the geographical location; and notifying the one or more second users of the newly available NFTs.

In some embodiments, the method further comprises enabling transactions between one or more second users. The transactions may for example include the trading, buying, selling and transferring of minted NFTs.

In some embodiments, the method further comprises assigning an expiry date to one or more of the minted NFTs and, upon determination that an expiry date of the NFT has been reached, marking the NFT as destroyed on the first blockchain.

In some embodiments, the step of minting one or more NFTs involves minting multiple unique NFTs simultaneously.

In some embodiments, one or more operations of the method are implemented via smart contracts hosted by the first blockchain.

In some embodiments, one or more operations of the method are compatible with multiple blockchains in addition to the first blockchain.

In some embodiments, the method further comprises the steps of: receiving a request from the second user to redeem one or more NFTs; determining the first user and first business associated with the one or more NFTs; and changing ownership of the redeemed one or more NFTs back to the original first user and notifying the first user that the one or more NFTs have been redeemed.

In some embodiments, the method further comprises providing an interface accessible by one or more user devices where a second user may verify their ownership of one or more NFTs.

In some embodiments, the method further comprises deducting a fee from any trade involving a minted NFT transacted over the first blockchain and distributing at least a portion of the deducted fee to the electronic wallet associated with the first user.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Embodiments of the present disclosure relate to the field of blockchain technologies and to a specific transact method on using a blockchain.

The present invention is a blockchain based system and method for NFT IP. The platform allows creators to monetize their assets via NFTs. The creators can distribute their intelligent property through the Polygon and Ethereum blockchains using the proprietary “browse, NFT Map and QR Code” functions for interactions between businesses and their customers in an effort to monetize their customer loyalty and tokenize their business programs after they setup and complete a profile on the platform.

The steps include fill your Web3 wallet with Matic Tokens from the Polygon Blockchain and use the app as described above after completing your profile and setup of Web3 Wallet. In another aspect, the invention is designed with an ERC-721 based protocol on the Ethereum blockchain.

One or more of the operations and calculations described herein may be performed by a cloud infrastructure comprising one or more servers and databases. This is merely an example infrastructure however, the servers need not necessarily be cloud-based. The cloud infrastructure may for example comprise a database configured to receive and store multimedia content and user data for a plurality of user accounts and a set of connected servers or nodes configured to enact the operations as disclosed herein.

The cloud infrastructure is configured to communicate with a set of client devices by various means over the network architecture. The client devices include devices configured to communicate with the cloud infrastructure via a communications tower. These devices may include but are not limited to a smartphone, a laptop, and a tablet computer.

Additional client devices configured to communicate with the cloud infrastructure via a networked computer modem include but are not limited to a smart display. Some of the connections may be wired connections, such as the connection between the smart display and the networked computer modem.

Any one of the client devices may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes communication tower.

While a specific set of client devices are listed as examples of the architecture, the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

Each client device may be associated with or “logged in” to a user profile in order to operate within the disclosed system and method, and further configured to send requests, upload user data, and generally interact with the cloud infrastructure via a user interface displayed on the device.

In this manner one or more users may access an online platform or web page in order to interact with the system and methods of the present disclosure through their user accounts.

Through this portal business owners may request to generate an NFT associated with their business enterprise, for example if the business owner owns a salon then one or more NFTs can be generated on a blockchain such as Ethereum, Matic, or Polygon which are associated with the Salon, the NFTS being tied to the intellectual property and brand image of the salon. In this manner store owners and various other types of business can generate tokens that are associated with their business and which can be distributed or sold to loyal customers, leveraging their existing customer base. This protocol allows the minting, listing, buying, selling, trading, transfer, and several other features.

For example, the NFTs may be used as gift cards, or rewards for customer loyalty. Each NFT minted for their business is secured by the intellectual property of that business and is configured so as to be exchanged for an enterprise reward at a given location or to represent a portion of the intellectual property of that business.

It may be required that the business owner meet one or more requirements before the NFT tokens are issued, such as for example signing an NFT licensing and distribution agreement, and/or abiding by the terms of this agreement while using the application as automatic approval of said terms of the NFT licensing and distribution agreement.

Once it is verified that the requirements have been met by the merchant the NFTs are minted by one or more nodes interacting with the blockchain and are issued to an electronic wallet address of the business owner on the appropriate blockchain for them to distribute, sell, and trade as they see fit.

A business owner can thus mint NFTs to leverage hidden value and intangible assets related to their business with minimal technological or blockchain know-how.

The tokens are generally issued to customers as a reward for loyalty, and can then be sold, traded, etc on a cryptocurrency marketplace.

In some examples, when the NFT tokens are minted and issued to the business owner, an online marketplace is also created for the owner to sell those NFTs along with other NFTs associated with their business. A unique identifier such as a QR code may also be generated and issued to business owner which allows for users to scan the QR code with their user devices to access that online marketplace.

Another aspect of one or more embodiments of the present specification is the “NFT Map.” The NFT Map displays the list and location of all the NFT's that users are creating/buying/selling and/or making available.

In such examples, each marketplace/QR code may be associated with a geographic location, i.e. for example the geographic location of the store/salon/other enterprise building they are associated with.

With multiple online marketplace geographic locations, a virtual map can be generated so that users can see nearby locations with available NFTs. This allows for users to be notified when new NFTs are issued near their location, through an app for example, and in turn brings additional foot traffic to the stores of the business owners. Customers may even be able to request to locate NFTs near their location through a dedicated software app.

The NFTs, the rewards, and the associated Unique Liftetime Benefit all contribute towards leveraging and solidifying the loyalty of existing customers of a business while also encouraging new customers to frequent their store/business.

In cases where the NFTs represent gift cards, these can be redeemed at the associated business by a customer in possession of them. A gift card can be redeemed through the customer accessing their electronic wallet where the NFT is stored, for example, and selecting to redeem it through the app interface. When this happens, the NFT is automatically transferred back to the business owner of that business, who is in turn notified that the gift card has been redeemed, and will then issue the product or service the gift card was redeemed for.

Customers may need to access their app through their user device to verify that it was them who possessed/redeemed the NFT in question.

In some cases, one or more of the NFTs may be configured to represent gift cards with expiry dates, and the system implementing the method may be configured to detect when a gift card NFT has passed its expiry date and mark that NFT as destroyed or no longer valid on the blockchain.

The step of minting the NFTs may involve minting multiple unique NFTs simultaneously, such as for example 5 or 10 at a time upon request from a business owner. These are custom NFTs and not just variations of an image.

These uses are all accounted for on the Polygon blockchain. When an NFT is purchased on the marketplace which is compatible with ERC-721, ERC-1155, ERC-2791 and other Ethereum compatible protocols as disclosed in the method, that buyer becomes the owner of the intellectual property tied to the unique lifetime benefit.

The operations disclosed herein thus result in a web3 enabled, Metamask-compatible NFT marketplace enhancing customer loyalty for any business. The method can be powered by the Polygon Blockchain, the Matic and VLR tokens, as well as other suitable blockchain technologies.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The marketplace is designed for different types of NFTs including but not limited to: Logos, Patents, Copyright, Trademarks, Art, Gaming, Dancing, People Interaction, Music, Writing, Contracts and Charity. Businesses are embracing NFT's (Non-Fungible Tokens) to unlock previously hidden value in their intellectual property within a broad range of categories such as: Art, Music, Barber Shop, Hair Salon, Cafe, Restaurant, Logo, Trademark, Writing, Film, Gaming, Entertainment, Contracts, Charity as well as any other Business or Property uses.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and related systems have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for issuing and transacting non-fungible tokens, NFTs, the method comprising the steps of:
receiving, from a first user, a request to generate an NFT associated with a first business enterprise;
verifying, by a server, that the first user meets a set of predefined requirements;
upon determining that the first user meets the predefined requirements, minting one or more NFTs associated with the first business on a first blockchain and registering the one or more NFTs to an electronic wallet associated with the first user;
receiving a request from the first user to transfer or trade one or more of the NFTs with a second user having a second electronic wallet associated with them on the first blockchain; and
changing the ownership of the one or more NFTs on the first blockchain to the second user;
wherein each NFT minted for the first business is secured by the intellectual property of that business and is configured so as to be exchanged for an enterprise reward at a given location or to represent a portion of the intellectual property of that business.

2. A computer-implemented method according to claim 1, wherein the method further comprises, for each NFT transferred to a second user, issuing a Unique Lifetime Benefit tied to the transferred NFT to the account of the second user, the Unique Lifetime Benefit entitling the second user to rewards from a business of a first user that requested the NFT be minted.

3. A computer-implemented method according to claim 1, wherein the predefined requirements verified in the second step comprise verifying that a contract has been signed by the first user.

4. A computer-implemented method according to claim 1, wherein the method further comprises the step of generating an online marketplace, accessible by one or more user devices, associated with the first user and the first business, the online marketplace listing one or more NFTs minted for and issued to the first user.

5. A computer-implemented method according to claim 4, wherein the method further comprises the step of generating a unique identifier associated with the online marketplace, the unique identifier being configured when scanned by a user device to direct the user device to the online marketplace of the associated first user.

6. A computer-implemented method according to claim 5, wherein the unique identifier is a QR code.

7. A computer-implemented method according to claim 5, wherein the unique identifier is associated with a physical geographical location, and wherein the method further comprises storing the geographical location of each unique identifier generated on a database.

8. A computer-implemented method according to claim 7, wherein the method further comprises generating a virtual map, accessible by one or more user devices, the virtual map indicating a plurality of geographical locations where unique identifiers for the online marketplaces of respective business are located.

9. A computer-implemented method according to claim 8, wherein the method further comprises the steps of:
determining that one or more new NFTs have been minted and associated with a geographical location;
determining a number of second users within a predefined radius of the geographical location; and
notifying the one or more second users of the newly available NFTs.

10. A computer-implemented method according to claim 1, wherein the method further comprises enabling transactions between one or more second users.

11. A computer-implemented method according to claim 10, wherein the transactions include the trading, buying, selling and transferring of minted NFTs.

12. A computer-implemented method according to claim 1, wherein the method further comprises assigning an expiry date to one or more of the minted NFTs and, upon determination that an expiry date of the NFT has been reached, marking the NFT as destroyed on the first blockchain.

13. A computer-implemented method according to claim 1, wherein the step of minting one or more NFTs involves minting multiple unique NFTs simultaneously.

14. A computer-implemented method according to claim 1, wherein one or more operations of the method are implemented via smart contracts hosted by the first blockchain.

15. A computer-implemented method according to claim 1, wherein one or more operations of the method are compatible with multiple blockchains in addition to the first blockchain.

16. A computer-implemented method according to claim 1, wherein the method further comprises the steps of:
receiving a request from the second user to redeem one or more NFTs;
determining the first user and first business associated with the one or more NFTs; and
changing ownership of the redeemed one or more NFTs back to the original first user and notifying the first user that the one or more NFTs have been redeemed.

17. A computer-implemented method according to claim 1, wherein the method further comprises providing an interface accessible by one or more user devices where a second user may verify their ownership of one or more NFTs.

18. A computer-implemented method according to claim 1, wherein the method further comprises deducting a fee from any trade involving a minted NFT transacted over the first blockchain and distributing at least a portion of the deducted fee to the electronic wallet associated with the first user.
